(19) United States
(12) Patent Application Publication
(10) Pub. No.: US 2013/0211876 A1
(43) Pub. Date: Aug. 15, 2013

(54) SYSTEM AND METHOD FOR COLLECTION, AGGREGATION, ANALYSIS, REPORTING, AND MONETIZATION OF PERSONAL DATA GENERATED ACROSS HETEROGENEOUS SYSTEMS AND DEVICES

(71) Applicant: Craig Perler, Larchmont, NY (US)

(72) Inventor: Craig Perler, Larchmont, NY (US)

(21) Appl. No.: 13/720,964

(22) Filed: Dec. 19, 2012

Related U.S. Application Data
(60) Provisional application No. 61/577,700, filed on Dec. 20, 2011.

(51) Int. Cl. G06Q 30/02; G06F 21/31

(52) U.S. Cl. CPC G06Q 30/0201; G06F 21/31
USPC 705/7.29; 726/28

(57) ABSTRACT

A method and system is disclosed for the authorization, collection, analysis, reporting, and monetization of personal data collected from heterogeneous external systems and electronic devices. The inventive system designates acting users as either data sellers or data purchasers. Data sellers may authorize the system for collecting personal data associated with accounts they hold across external systems or on digitally-accessible electronic devices. Collected data, as well as analytics and charting based on collected data, is reportable in various forms to the data seller. The inventive system defines a mechanism for allowing sellers direct access for monetizing their personal data. Data purchasers may attempt engaging with data sellers to create a data-based transaction: the seller receives some pre-defined benefit or incentive for participating in the transaction; the purchaser receives access to data, data-based analytics, or some form of digital or physical response from the seller.

### CROSS REFERENCE TO RELATED APPLICATIONS

This application claims the benefit of Provisional Patent Application No. 61/577,700 entitled SYSTEM AND METHOD FOR CONSUMER CONTROL OF MARKETING DATA Filed Dec. 20, 2011, the disclosure of which is hereby incorporated herein by reference.

### TECHNICAL FIELD

The invention relates to a system and method for collecting, aggregating, analyzing, reporting, and monetizing personal data generated by individuals across any number of heterogeneous systems and electronic devices and methods for implementing the same, for example, such as on a publicly electronic communications network, such as the Internet. The system and method retrieves information about personal data generated by users from heterogeneous systems and devices; organizes and aggregates that data; analyzes that data on a per-user basis and in aggregate; generates and displays reports about the data and analysis; and provides mechanisms for individuals to monetize the personal data collected from heterogeneous systems and electronic devices by the system and method.

### STATEMENT REGARDING FEDERALLY SPONSORED RESEARCH OR DEVELOPMENT

(Not applicable)

### BACKGROUND OF THE INVENTION

This invention pertains in general to data collection, analysis, reporting, and monetization mechanisms, and in particular to data collection, analysis, reporting, and monetization mechanisms of personal data generated by users across heterogeneous systems and electronic devices.

With the proliferation of computers and electronic communication networks, data and information, as it pertains to describing individuals, their attributes, activities, behaviors, intents, and other similar characteristics, is increasingly made available and accessible across electronic devices and digital mediums.

An individual's activities, experiences, relationships, preferences, and intentions across heterogeneous systems and electronic devices are often made accessible given proper authorization by that individual's explicit permission. It's often the case, however, that such preference information and the like is collected and analyzed without the knowledge of the consumer allowing firms to avoid tying personally identifiable information (PII) to preference information.

Conventional mechanisms for tracking personal data without tying that back to personally identifiable information are well-known, such as utilizing digital cookies, embedded beacons, analysis of log files, or direct installation of small software utilities. These mechanisms, on a per instance basis, are only able to access a very small subset of personal data as without permission to associate that personal data back to personally identifying information, it is impossible to relate all bits of personal data for a given individual together. Consequently, though there is already an established ecosystem around the aggregation and analysis of personal data, this ecosystem is disadvantaged by the fact that associating data across heterogeneous systems and electronic devices can only be done in an anonymous, aggregate fashion as without explicit personally identifying information, relationships across disparate data sets may only be inferred implicitly.

This invention describes a mechanism through which individuals may opt in to provide explicit access to their personal information across heterogeneous systems and electronic devices for the purposes of providing analysis, reporting, and monetization opportunities. Given opt-in access, this invention is thus able, for a given participating user, to associate personal data across heterogeneous systems and electronic devices.

Combining personal data with personally identifying information allows for the invention to analyze, report, and monetize the personal data that individuals have generated across heterogeneous systems and electronic devices, such as could be accomplished on a publicly electronic communications network, such as the Internet. Such monetization mechanisms as provided by this invention provide direct payment back to the individuals who provide opt-in access to their personal data across heterogeneous systems and electronic devices, a key difference and one that is not possible in the pre-existing ecosystem of anonymous, not-identifiable, personal data.

### SUMMARY OF THE INVENTION

The inventive system and method provides mechanisms for permitting individuals to authorize the invention access to that individual's personal data across heterogeneous systems and electronic devices for purposes of collecting, aggregating, analyzing, reporting, and monetizing that individual's personal data. In one embodiment, authorization, in a general sense, may be defined across a set of broad or specific rules. Individuals may grant the invention permission to an entire set of personal data accessible from any given instance across all heterogeneous systems and electronic devices; or, as one example, an individual may grant the invention access only to a subset of personal data from any given instance across all heterogeneous systems and electronic devices.

In another embodiment, the invention includes a collection module that periodically or continuously retrieves personal data from individually authorized heterogeneous systems and electronic devices. In such an embodiment, the collected personal data is persisted, such as into a database, for immediate or later analysis, display, reporting and monetization.

In accordance with the invention, a mechanism for displaying collected data and associated analyses is achieved. Generally, personal data may be displayed in any number of organizational mechanisms and layouts. For example, in one instance, personal data may be displayed as organized by heterogeneous system or electronic device; other instances may permit organizing personal data in other manners, aggregating such data, filtering data, or searching data. The display provides modules for managing the previously granted collection authorizations of personal data across heterogeneous systems and electronic devices, granting new authorizations similarly, and interacting with categorical fields and controls that allow for visualizing collected personal data, such as might be accomplished over a web page accessed via the Internet and seen on a computer monitor.

In another embodiment, the invention includes an analysis module that can apply statistical, quantitative, and/or extract-transform-load (ETL) algorithms across collected personal data. In such an embodiment, applied algorithms may generate analytics and trends or find patterns which can themselves be associated to the collected and now analyzed set of personal data. Further, such trends and patterns may have visual components, such as graphs and charts, which can be displayed in accordance with previous embodiments.

In a further embodiment, the invention provides various mechanisms for the monetizing of collected personal data. In general, such monetization mechanisms offer incentives and benefits to the individuals who authorized the collection of the personal data associated with the monetization transaction. For example, in return for incentives and benefits, in one instance, certain individuals may make themselves available for targeted engagement by companies of interest whereby targeted engagement may come in one of many forms, such as but not limited to distribution of deals to attract customer interest, surveys to facilitate market research, or emails to enable lead generation. Such example monetization mechanisms allow individuals to provide controlled access to their personal data, with varying degrees of visibility, analysis thereof, or targeted communication based on the same, in exchange for incentives and benefits. In such an example, a number of graphical user interfaces are provided, allowing individuals control to decide over which monetization schemes they wish to participate and to what degree and capacity. Further, in such an example, additional graphical user interfaces are provided that allow companies interested in targeting individuals such as previously described to manage campaigns that describe the types of individuals they wish to target, the medium through which they wish to target those individuals, the incentives and benefits to convey to those individuals, and similar characteristics that would be required for running such a campaign.

To generalize further on the previous embodiment, the monetization module allows various mechanisms for individuals and companies to buy access to personal data or derivatives thereof. For example, firms could use the invention to run communication campaigns or for targeting incentives towards a focused customer segment. Given campaign parameters, the invention identifies matching individuals, and via a real-time auction or for a per person fee split between the individual and the invention, the invention acts as intermediary for facilitating engagement. Communication comes in various forms, such as surveys, open dialogues, direct deals, and social-shareable incentives. Analytics such as quality scores and participation ratings enrich user data, so the invention provides guidance during targeting. In such an example, the invention provides numerous graphical user interfaces for managing both sides of the engagement and transaction.

### BRIEF DESCRIPTION OF THE DRAWINGS

One or more embodiments of the invention and ways of making and using the invention, as well as the best mode contemplated of carrying out the invention are described in detail below, by way of example, with reference to the accompanying drawings, in which:

FIG. 1 is a block diagram of an apparatus for implementing an exemplary embodiment of the method according to the present invention;

FIG. 2 is a flow chart generally illustrating a general implementation of the method of the present invention;

FIGS. 3-6 illustrate screens presented in accordance with the method of the present invention;

FIG. 7 illustrates the preferred embodiment of the internal and external components generally associated with the method of the invention.

### DETAILED DESCRIPTION OF THE PREFERRED EMBODIMENTS

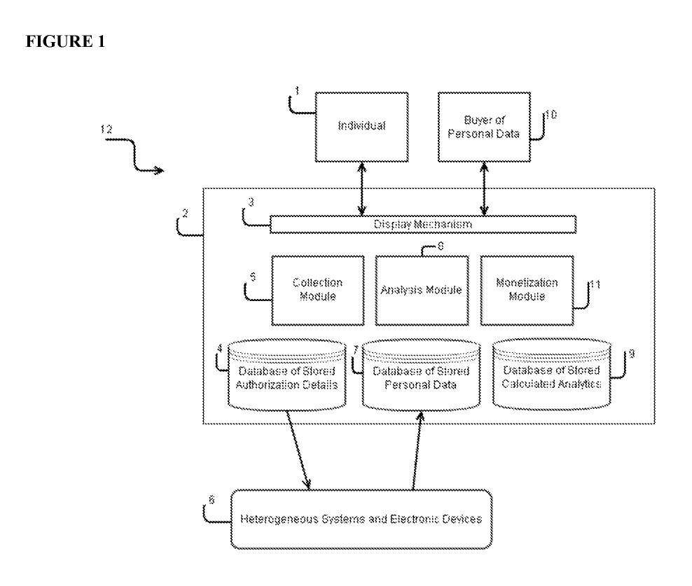

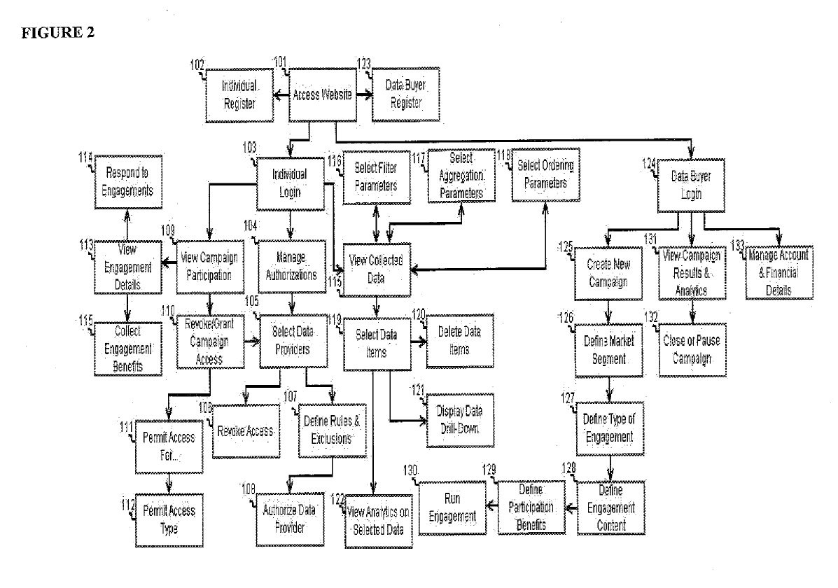

FIG. 1 illustrates apparatus 12 for implementing the inventive method. Where practical, number of elements in FIG. 1 is between 1 and 99 for purposes of clarity. FIG. 2 illustrates a block diagram of the method of the present invention. Where practical, numbering of elements in FIG. 2 is between 100 and 199 for purposes of clarity of explanation. Method 101 is commenced by a potential individual 1 and/or a potential buyer of personal data or related engagement 10, such as a potential individual 1 and/or a potential buyer of personal data or related engagement 10 accessing the website at process 101. Such access is made by, for example, via the Internet (not labeled).

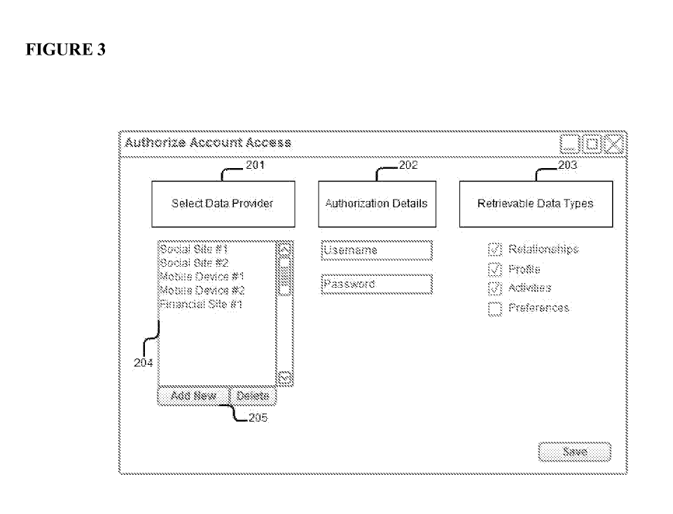

FIGS. 3-6 illustrate screens presented to potential individual 1 and/or potential buyer of personal data or related engagement 10 over the Internet. These illustrated screens, for purposes of clarity of illustration, do not include conventional element as supplied, for example by an Internet browser, such as Microsoft Internet Explorer, or search engine websites, such as Google; however, the same would appear on an actual monitor or display screen implementing the invention. Where practical, numbering of elements in FIGS. 3 through 6 is between 200 and 299 for purposes of clarity of explanation.

At step 104, in response to an individual user 1 accessing the inventive system, the inventive system responds with one of 102, 103, 123 or 124. Such screens help distinguish whether the acting user is an “individual” or “seller” or “data seller” 1, or generic provider of data in the inventive system, or a “buyer” or “data buyer” 10, a generic purchaser of data in the inventive system. Once distinguished, the set of screens made accessible to either party is segregated as per FIG. 2.

After authenticating via 103, an individual 1 has access to screens including but not limited to FIGS. 3, 4 and 5. FIG. 3, referring to process 104 permits an individual 1 to designate which external systems or electronic devices 6 should be included within the collection module 5. Generally, FIG. 3 describes how an individual 1 can designate via 205 which external systems or electronic devices 6 to include in the collection process, whereupon such selection is then stored in database 4, and noted visually such as in 204.

For a given external system or electronic device 6, an individual 1 may need to provide meta-data or authorization details in order to permit the collection module 5 to operate. Such authorization details may be provided in controls 202 and stored in database 4.

An individual 1 may further refine the provisions of the collection module 5 by entering additional rules, such as explained with processes 106 and 107. These rules could generally be placed in controls such as 203. Upon completing process 108, all details provided in controls of FIG. 3 are then persisted to a database, such as 4.

After collection module 5 has run for a given set of authorized providers 6 for a given individual 1, that data is persisted to data storage device as well, such as 7.

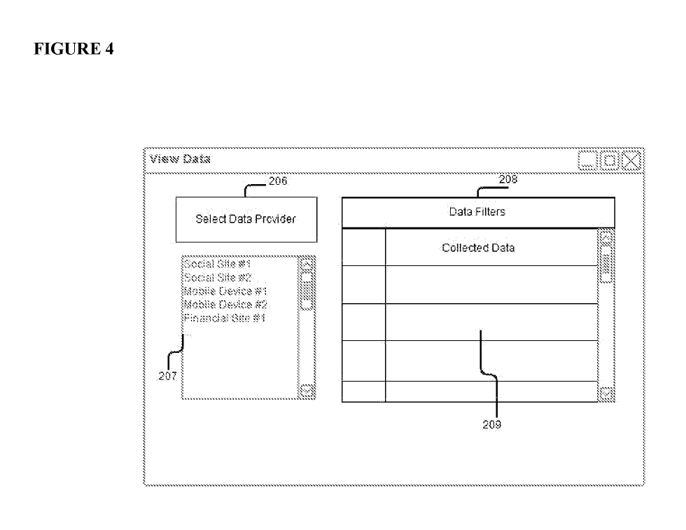

An individual 1 may view data collected from external systems and electronic devices 6 as per FIG. 4, and documented in process 115. From process 115, controls 207 and 208 allow for filtering, aggregating, sorting, ordering, and analyzing the collected data. Such general processes 116-122 document this data presentation and reporting aspects 209 of the inventive system.

Data collected from external systems and electronic devices 6, once saved in a storage device such as 7, may then be integrated into the analysis module 8 whereby additional analytics based on the collected data are computed, and then persisted as well such as in storage device 9.

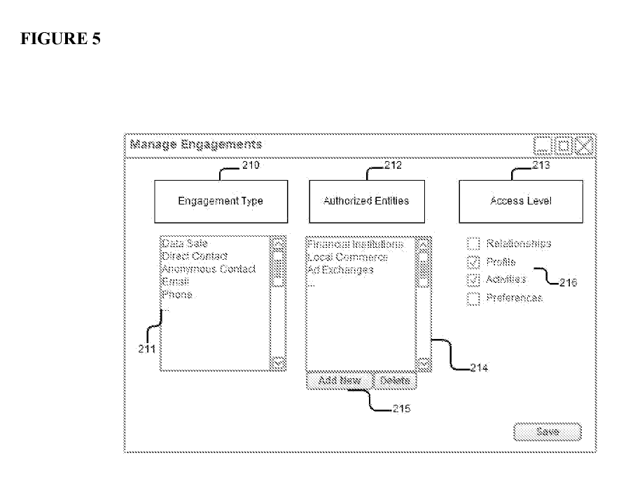

An individual 1 has access via monetization module 11 to the screen generally depicted in FIG. 5. From FIG. 5, an individual 1 may manage processes 109-115. With control 211, an individual 1 could decide, for example, that a given type of communication is acceptable for a given selected entity per 212 specifically related to processes 110 and 111. Finer level controls are generally available such as in 216, referring to process 112.

Process 113 relates to the results of a monetization effort whereby an individual 1 has received communication, benefits, or incentives in return for providing access to data collected via external systems or electronic devices 6.

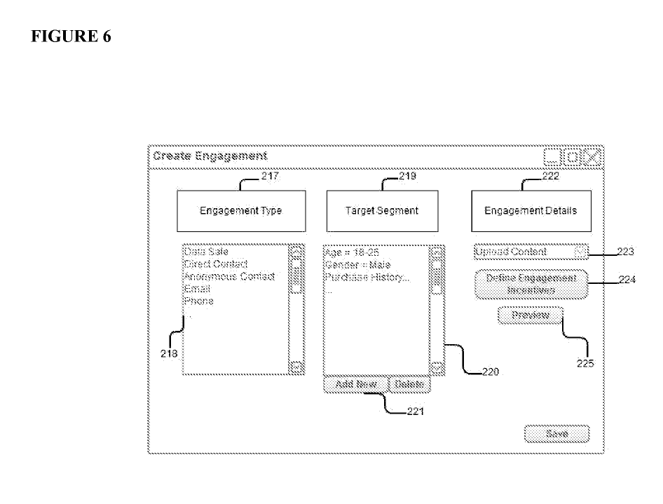

A data purchaser 10, among many other screens, has access to that depicted in FIG. 6, referring to process 125. From control 218 a data purchaser 10 may define the type of data purchase of which they're interested, as in process 127. Controls 220 and 221, referring to process 126, allow a data purchaser 10 to build up a target market segment. Such a segment, which could be defined by an arbitrarily large or complex set of rules, could then be used for targeting in a monetization module 11 execution.

A data purchaser 10 may also need to provide custom content as part of an engagement campaign, and control 223 relating to process 128 permits such content specification.

A data purchaser 10 may also provide benefits or incentives as part of a monetization campaign, and control 224 generally provides access to such processes as noted in 129.

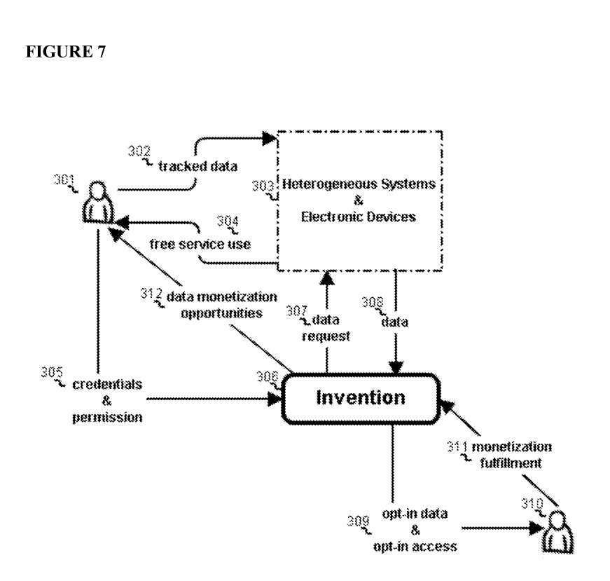

Referring to FIG. 7, a flowchart for software for performing the method of the present invention as outlined in FIGS. 1-6 is illustrated. Where practical, numbering of elements in FIG. 7 is between 300 and 399 for purposes of clarity of explanation. In FIG. 7, an individual 301 provides authorization details 305 to the invention 306. The invention 306 is then able to request data 307 from external systems and electronic devices 303, and retrieve back personal data 308 which relates to the personal data 302 which individual 301 had provided through prior actions and selections. Invention 306 also provides monetization opportunities 312 to individual data providers 301. Such opportunities leverage the interest of data buyers 310, whereby a buyer would express intent to purchase data or data-based engagement 309, providing the invention some sort of benefit or incentive 311 to pass back to the data-providing individuals 301.

While an illustrative embodiment of the invention has been described, it is understood that some variations and equivalents are within the scope of the invention which is defined by the claims and their elements, including equivalents thereof.

What is claimed:

1. A method for collecting, analyzing, reporting, and allowing monetization opportunities for personal data collected from any number of heterogeneous external systems and electronic devices, comprising:
a. presenting a screen display on a computer monitor or similar device, said screen display comprising a number of views comprised of fields and controls for allowing individuals to authorize access to external systems and electronic devices for purposes of collecting personal data;
b. presenting, as part of managing such authorization access, a data provider element from which selection of a plurality of data providers may be chosen;
c. further presenting a set of fields for managing authorization access, such as account names and password credentials;
d. further presenting a set of fields for further designating specific types of personal data to collect from external systems and electronic devices;
e. collecting, upon persistence of said authorization information, the designated set of personal data from the designated set of external systems and electronic devices on a continuous and/or periodic basis;
f. storing, such as in a database, personal data collected by the inventive system;
g. displaying said collected personal data in detailed, aggregate, or filtered form with varying degrees of specificity and aggregation achievable through selection of one or more filters or selection controls;
h. receiving and acting upon requests from individual data authorizers to modify previously designated authorization requests such that collected personal data or authorization details may be removed or deleted from a collection database maintained by the inventive system.

2. A method as in claim 1, further comprising:
a. displaying a set of controls for authenticating entities accessing the inventive system for purposes of designating such entities as “data authorizer” (also herein labeled as “user” or “individual”) or a “data purchaser”;
b. receiving authorization details from said entity for either registering or logging into the inventive system as a data authorizer or a data purchaser.

3. A method as in claim 2, further comprising:
a. analyzing a set or subset of collected personal data;
b. storing, such as in a database, analyzed metrics based on said analysis of collected personal data;
c. displaying visual reports and/or statistics based on computed analytics of collected personal data upon selected interest from an individual.

4. A method as in claim 3, further comprising:
a. receiving a request from a user to participate in personal data monetization opportunities;
b. receiving parameters describing said monetization opportunities whereby said parameters are designated by a plurality of elements including but not limited to:
i. selecting a plurality of types of engagement in which to participate;
ii. selecting a plurality of data purchasers with whom to permit engagement for a given selection of engagement type;
iii. selecting a plurality of personal data types to which a given authorized data purchaser may have access within scope of a monetization campaign;
c. enabling the requesting user to participate in a monetization campaign whereby that user's personal data becomes accessible in various capacities defined by previously described monetization parameters;
d. displaying to the user varying forms of engagement resulting from said monetization campaigns, such as but not limited to requests from data purchasers to buy collected personal data directly and direct and indirect digital communication requests;
e. displaying to the user benefits or incentives they may claim for willingly participating in a personal data monetization campaign;
f. receiving interest from a user in responding to a selected occurrence of a monetization campaign whereby such interest is communicated back to the data buyer in the form of a digital acknowledgement or digital response as deemed appropriate by the personal data monetization campaign parameters;
g. providing to the user's managed financial account or directed digital or physical address the defined benefits or incentives granted to the user upon responding or agreeing to the terms associated with the personal data monetization campaign parameters.
h. presenting to the user a dashboard of information summarizing personal data monetization campaign details, including but not limited to reports as to what personal data has been authorized, how, and to whom.

5. A method as in claim 4, further comprising:
a. selection from a data purchaser intent to create a new personal data monetization campaign;
b. further selection from a data purchaser within context of creating a new personal data monetization campaign a plurality of parameters for defining the engagement, target segment, content, and benefits associated with said campaign whereby such parameters include but are not limited to:
i. a selection of the type of communication to establish with data sellers, such as direct or indirect communication, or express desire to purchase personal data directly;
ii. a selection of a plurality of attributes for defining a target segment of data sellers from whom personal data is of interest for the given data purchaser;
iii. elements for defining content to be displayed to data sellers as part of participating in the said campaign;
iv. further elements for defining the benefits and incentives a data seller incurs upon participating in said campaign;
c. receipt from a data purchaser to start a defined personal data monetization campaign;
d. storage of personal data monetization campaign details and parameters.

6. A method as in claim 5, further comprising:
a. displaying elements permitting data purchaser to manage previously defined personal data monetization campaigns such as controls for starting, stopping, and pausing said campaigns;
b. displaying elements for reviewing progress and reports of said campaigns;
c. displaying elements for updating the parameters associated with a previously defined personal data monetization campaign;
d. receiving, upon selection from a data purchaser, indication to adjust campaign parameters or status and acting upon said selection to modify the personal data monetization campaign accordingly.

7. A method as in claim 6, further comprising:
a. billing data purchasers for participating in a personal data monetization campaign;
b. crediting data sellers, either monetarily or as defined by the personal data monetization campaign, for participating in said campaign.
